(19) United States
(12) Patent Application Publication
(10) Pub. No.: US 2012/0050951 A1
(43) Pub. Date: Mar. 1, 2012

(54) Lithium ion capacitor

(75) Inventors: Hak Kwan Kim, Hanam-si (KR); Bae Kyun Kim, Seongnam-si (KR); Hong Seok Min, Yongin-si (KR); Dong Hyeok Choi, Suwon-si (KR)

(73) Assignee: SAMSUNG ELECTRO-MECHANICS CO., LTD., Suwon (KR)

(21) Appl. No.: 12/929,634

(22) Filed: Feb. 4, 2011

(30) Foreign Application Priority Data
Aug. 27, 2010 (KR) 10-2010-0083379

(51) Int. Cl. H01G 9/145

(52) U.S. Cl. 361/508

(57) ABSTRACT

Provided is a lithium ion capacitor. The lithium ion capacitor includes an electrode cell having cathodes and anodes alternately stacked with separators interposed therebetween, an electrolyte immerging the electrode cell and a housing to receive the electrode cell immerged into the electrolyte. Here, the electrolyte includes a carbonate group solvent and a viscosity control solvent.

### CROSS-REFERENCE TO RELATED APPLICATIONS

This application claims the benefit of Korean Patent Application No. 10-2010-0083379 filed with the Korea Intellectual Property Office on Aug. 27, 2010, the disclosure of which is incorporated herein by reference.

### BACKGROUND OF THE INVENTION

1. Field of the Invention

The present invention relates to a lithium ion capacitor, and more particularly, to a lithium ion capacitor including a carbonate group solvent and a viscosity control solvent.

2. Description of the Related Art

Electrochemical capacitors have been attracting attention as high quality energy sources in a renewable energy system that can be applied to electric vehicles, hybrid vehicles, fuel cell vehicles, heavy equipment, mobile electronic terminals, and so on. Such electrochemical capacitors are referred to as various names such as supercapacitors and ultra capacitors.

Such an electrochemical capacitor is classified into an electric double layer capacitor using an electric double layer principle and a hybrid super capacitor using an electrochemical oxidation-reduction reaction. Although the electrochemical capacitor has been widely used in a field required to high power energy characteristics, the electric double layer capacitor has a problem such as a small capacity. On the contrary, the hybrid super capacitor has been widely studied as a new method to improve the capacity characteristics of the electric double layer capacitor. Specifically, a lithium ion capacitor (LIC) among the hybrid super capacitor may have accumulation capacity of 3 times to 4 times in comparison with the electric double layer capacitor.

On the other hand, the lithium ion capacitor can include an electrode cell immerged into an electrolyte. Here, the lithium ion capacitor may have a high discharge voltage in comparison with the other electrochemical capacitors. Here, in order that the lithium ion capacitor generates a high driving voltage, the electrolyte can be used by mixing the carbonate group solvent capable of being stable electrochemically in 0 to 4.2V as a discharging and charging voltage range.

However, since the carbonate group solvent can increase the viscosity of the electrolyte, there is a limitation to an application of mass production by requiring a long time in completely immerging the electrode into the electrolyte as well as it becomes a factor to increase the inner resistance of the lithium ion capacitor.

Accordingly, although the electrolyte of the lithium ion capacitor requires for the carbonate group solvent capable of being stable electrochemically, there are problems to deteriorate the mass productivity of the lithium ion capacitor and to increase the inner resistance due to the high viscosity of the carbonate group solvent.

### SUMMARY OF THE INVENTION

The present invention has been invented in order to overcome the above-described problems and it is, therefore, an object of the present invention to provide a lithium ion capacitor including a carbonate group electrolyte and a viscosity control electrolyte to control the viscosity of the carbonate group electrolyte.

In accordance with one aspect of the present invention to achieve the object, there is provided a lithium ion capacitor an electrode cell including cathodes and anodes alternately stacked with separators interposed therebetween, an electrolyte immerging the electrode cell; and a housing to receive the electrode cell immerged into the electrolyte, wherein the electrolyte includes a carbonate group solvent and a viscosity control solvent.

The viscosity control solvent includes a viscosity ranging from 0.3 mPa.S to 1.0 mPa.S.

Here, the viscosity control solvent includes an ionic liquid.

And also, the viscosity control solvent includes at least one of EMI⁺[N(CF₃SO₂)₂]⁻, EMI⁺[BF4]⁻, EMI⁺(CF3SO3]⁻, BMI⁺[N(CF₃SO₂)₂]−, MPP⁺[N(CF₃SO₂)S]⁻, MPP⁺[N(CN)2], BPi⁺[BF4]⁻ and BPi⁺[N(CF₃SO₂)₂]−, wherein the EMI is 1-ethyl-3-methylimidazolium, the BMI is 1-butyl-3-methylimidazolium, the MPP is 1-methyl-propylpiperidinium and the Bpi is Butyl pyridinium.

And also, the electrolyte includes at least one among LiPF₆, LiBF₄ and LiClO₄.

And also, the carbonate group solvent includes at least one among propylene carbonate, ethylene carbonate, diethyl carbonate, dimethyl carbonate and ethyl methyl carbonate.

And also, the viscosity control solvent has a volume ratio ranging from ⅓ time to one time with reference to the carbonate group solvent.

And also, the anode includes an anode collector and an active material layer disposed at least one surface of the anode collector and included therein pre-doped lithium ions.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a lithium ion capacitor in accordance with an embodiment of the present invention;

FIG. 2 is an assembled perspective view of the lithium ion capacitor in accordance with the embodiment of the present invention; and

FIG. 3 is a cross-sectional view taken along a line I-I′ of an electrode cell shown in FIG. 2.

### DETAILED DESCRIPTION OF THE PREFERABLE EMBODIMENTS

Hereinafter, embodiments of the present invention for a lithium ion capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

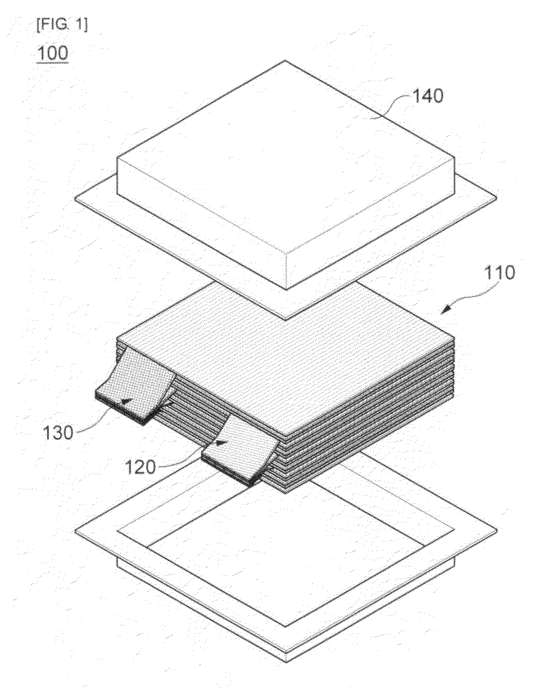

FIG. 1 is an exploded perspective view of a lithium ion capacitor in accordance with an embodiment of the present invention.

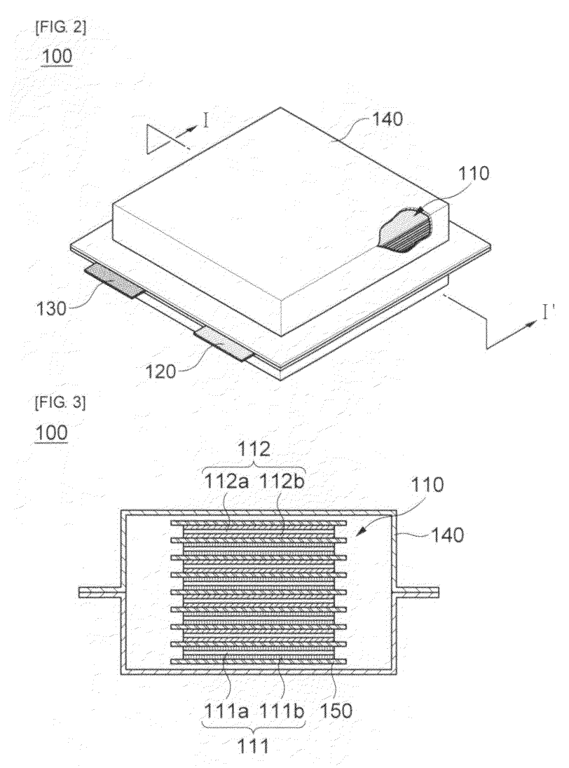

FIG. 2 is an assembled perspective view of the lithium ion capacitor in accordance with the embodiment of the present invention.

FIG. 3 is a cross-sectional view taken along a line I-I′ of an electrode cell shown in FIG. 2.

Referring to FIGS. 1 to 3, a lithium ion capacitor 100 in accordance with an embodiment of the present invention may include an electrode cell 110, an electrolyte and a housing 140.

Here, the electrode cell 110 may include cathodes 111 and anodes 112, which are alternately disposed with separators 150 interposed therebetween.

The separator 150 may play a role of electrically separating the cathodes 111 and the anodes 112 from each other. Although the separator 150 is a paper or a fabric, in the embodiment of the present invention, it is not limited to the type of the separator 150.

The cathodes 111 can include a cathode collector 111a and a cathode active material layer 111b arranged at both sides of the cathode collector 111a.

Here, the cathode collector 111a can be formed of metal, e.g., any one among aluminum, stainless, copper, nickel, titanium, tantalum and niobium. Although the cathode collector 111a may have a shape of thin film, the cathode collector 111a may include a plurality of throughholes to effectively perform the movement of ions and a uniform doping process.

In addition, the cathode active material layer 111b may include a carbon material, i.e., activated carbon, to which ions can be reversibly doped and undoped. Further, the cathode active material layer 111b may further include a binder. Here, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on. Further, the cathode active material layer 111b may further include a conductive material, for example, carbon black, solvent, and so on.

Here, the cathode 111 may include a cathode terminal 120 to be connected to an external power source. At this time, the cathode terminal 120 may be formed by being extended from one side of the cathode collector 111a.

The anode 112 can include an anode collector 112a and an anode active material layer 112b arranged at both surfaces of the anode collector 112a, respectively.

Here, the anode collector 112a can be formed of metal, e.g., any one among copper, nickel and stainless. Although the anode collector 112a may have a shape of thin film, the anode collector 112a may include a plurality of throughholes to effectively perform the movement of ions and a uniform doping process.

And also, the anode active material layer 112b can use a carbon material capable of doping or dedoping the lithium ions reversely , for example, the anode active material layer 112b can use any one among natural graphite, fabric graphite, MCF (Mesophase pitch based carbon fiber), MCMB (MesoCarbon MicroBead), graphite whisker, graphite carbon fibers, hard carbon, polyacene group organic semiconductor, composite carbon material of carbon material and graphite material, pyrolysis material of furfuryl alcohol resin, pyrolysis material of novolac resin, and pyrolysis material of condensation polycyclic hydrocarbon such as pitch and cokes or the like or use by mixing more than two.

And also, the lithium ions can be pre-doped into the anode active material layer 112b. Accordingly, the energy density of the lithium ion capacitor can be increased by reducing the potential of the anode 112 to the potential of the lithium, i.e., approximately 0V. At this time, the potential of the anode 112 can be controlled by controlling the pre-doping process of the lithium ions.

Here, the anode 112 may include an anode terminal 130 to be connected to an external power. At this time, the anode terminal 130 can be formed by being extended at one side of the anode collector 112a. That is, the anode collector 112a and the anode terminal may be formed as one body.

Although the embodiment of the present invention has shown and described the electrode cell 110 as a pouch type, but it is not limited to this. The electrode cell 110 may be a wound type in which the cathodes, the anodes and the separators are wound in a roll shape.

Here, the electrode cell 110 is immersed in the electrolyte. At this time, the active material layer of the cathodes, the active material layer of the anodes and the separator may be immersed in the electrolyte.

The electrolyte may function as a medium for migration of lithium ions, and may include an electrolyte and solvent. Here, the electrolyte may be a salt, for example, lithium salt or ammonium salt. At this time, the lithium salt may include any one of LiPF₆, LiBF₄, LiClO₄, and so on. Here, the lithium salt can play a role of a supply source of the lithium ions doped as the anodes during charging the lithium ion capacitor.

Also, the electrolyte may be made of a material capable of keeping the lithium ions stable without generating the electrolysis at the high voltage. Accordingly, the solvent of the electrolyte may use a carbonate group solvent. The solvent may be, for example, propylene carbonate, ethylene carbonate, diethyl carbonate, dimethyl carbonate and ethylmethyl carbonate, and so on. Here, the solvent may be used by mixing one or two or more.

At this time, as the carbonate group solvent has a viscosity ranging from 0.7 mPa.S to 2.5 mPa.S, the mass production time of the lithium ion capacitor may be deteriorated since the time until the electrode cell 110 is completely immerged into the electrolyte becomes long relatively due to the viscosity increment of the electrolyte.

Accordingly, in order to reduce the viscosity of the electrolyte in comparison with that of the carbonate group solvent, the electrolyte may further include a viscosity control solvent.

The viscosity control solvent may have a low viscosity lower than that of the carbonate group solvent. Here, the viscosity control solvent may have a viscosity, e.g., ranging from 0.3 mPa.S to 1.0 mPa.S considering on the immersion property and the low temperature property or the like of the electrode cell 110. Here, if the viscosity of the viscosity control solvent is below 0.3 mPa.S, a phase separation may be generated without generating the mixing of the viscosity control solvent and the carbonate group solvent. Whereas, if the viscosity of the viscosity control solvent becomes over 1.0 mPa.S, the improvement of the immersion property or the low temperature property cannot be expected to the electrode cell 110.

As like this, as the viscosity of the electrolyte reduces, the mass productivity can be secured by improving the electrolyte immersion property to the electrode.

Also, the rapid reduction of the discharge capacity of the lithium ion capacitor can be prevented at a temperature below the room temperature, e.g., ranging from −20° C. to 20° C. as the viscosity of the electrolyte becomes low. That is, the lithium ion capacitor may have excellent low temperature characteristics.

Meanwhile, if the lithium salt, particularly to the LiPF₆ having an excellent ion conductivity, may be used as the electrolyte, the LiPF₆ may be easily hydrolyzed by moisture capable of being contained during the manufacture of the lithium ion capacitor. And also, the HF generated from the hydrolyzed results plays a role of facilitating the dissolving reaction of the solvent as well as affects the corrosion of the electrode. That is, the lithium salt used as the electrolyte has the problems to deteriorate the lifetime and the reliability of the lithium ion capacitor.

At this time, the viscosity control solvent may have a shape of ionic liquid. Here, if the viscosity control solvent uses the ionic liquid, since the ionic liquid can play a role of the electrolyte, the amount of the lithium salt capable of being used as the electrolyte can be reduced. Accordingly, the generation amount of HF can be suppressed. That is, since the viscosity control solvent can deteriorate the viscosity of the electrolyte as well as play the role of electrolyte, the lifetime and the reliability of the lithium ion capacitor can be increased.

And also, since the ionic liquid has a heat resistance property, a flame resistance, a low vapor pressure and high ion conductivity, the electrochemical stability of the lithium ion capacitor can be secured.

And also, as the ionic liquid has the ion conductivity higher than that of the carbonate group solvent, the high efficiency charging/discharging property of the lithium ion capacitor can be improved.

Here, an example of the viscosity control solvent may be a solvent mixed by any one or two or more. among EMI⁺[N(CF₃SO₂)₂]⁻, EMI⁺[BF4]⁻, EMI⁺(CF3SO3]⁻, BMI⁺[N(CF₃SO₂)₂]−, MPP⁺[N(CF₃SO₂)S]⁻, MPP⁺[N(CN)2], BPi⁺[BF4]⁻ and BPi⁺[N(CF₃SO₂)₂]−. Here, the EMI is 1-ethyl-3-methylimidazolium, the BMI is 1-butyl-3-methylimidazolium, the MPP is 1-methyl-propylpiperidinium and the Bpi is Butyl pyridinium.

And also, the viscosity control solvent has a volume ratio ranging from ⅓ time to one time with reference to the carbonate group solvent, as considering on the cost of material and the electrochemical property. Here, if the viscosity control solvent is mixed below the ⅓ time, the viscosity of the electrolyte cannot be reduced to the degree capable of improving the immersion property of the electrolyte. Whereas, if the viscosity control solvent becomes over the ⅓ time, the immersion property of the electrode can be improved, but the electric conductivity can be reduced. In this result, the electric characteristics of the lithium ion capacitor may be deteriorated.

The housing 140 seals the electrode cell 110 immersed into the electrolyte from the outside thereof. Here, although the housing 140 can be made of a laminated film or a metal can thermally fused with placing the electrode cell 110 therebetween, the shape of the housing 140 is not limited in the embodiment of the present invention.

As like the embodiments of the present invention, since the electrolyte includes the carbonate group solvent and the viscosity control solvent, the electrochemical stability of the electrolyte can be secured and the viscosity of the electrolyte can be reduced, which will, in turn, can improve the mass productivity and the low temperature property of the lithium ion capacitor.

And also, as the viscosity control solvent is used as the ionic liquid, the lithium ion capacitor prevents the inner resistance thereof from being increased, the lifetime and the reliability of the lithium ion capacitor can be increased and the high efficiency charging/discharging property can be improved.

The lithium ion capacitor in accordance with the present invention can secure a heat resistance property, a flame resistance, a low vapor pressure and high ion conductivity and can reduce the viscosity of the electrolyte by using the mixture of the carbonate group solvent and the viscosity control solvent, the mass productivity and the low temperature property of the lithium ion capacitor can be improved.

And also, since the viscosity control solvent of the lithium ion capacitor in accordance with the embodiments of the present invention uses the ionic liquid, the lithium ion capacitor can prevent the inner resistance thereof from being increased and can improve the lifetime and the reliability of the lithium ion capacitor and can improve the high efficiency charging/discharging property.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A lithium ion capacitor comprising:
an electrode cell including cathodes and anodes alternately stacked with separators interposed therebetween;
an electrolyte immerging the electrode cell; and
a housing to receive the electrode cell immerged into the electrolyte,
wherein the electrolyte includes a carbonate group solvent and a viscosity control solvent.

2. The lithium ion capacitor according to claim 1, wherein the viscosity control solvent includes a viscosity ranging from 0.3 mPa·S to 1.0 mPa·S.

3. The lithium ion capacitor according to claim 1, wherein the viscosity control solvent includes an ionic liquid.

4. The lithium ion capacitor according to claim 1, wherein the viscosity control solvent includes at least one of EMI⁺[N(CF₃SO₂)₂]⁻, EMI⁺[BF4]⁻, EMI⁺(CF3SO3]⁻, BMI⁺[N(CF₃SO₂)₂]−, MPP^{+[N(CF}₃SO₂)S]⁻, MPP⁺[N(CN)2], BPi⁺[BF4]⁻ and BPi⁺[N(CF₃SO₂)₂]−, wherein the EMI is 1-ethyl-3-methylimidazolium, the BMI is 1-butyl-3-methylimidazolium, the MPP is 1-methyl-propylpiperidinium and the Bpi is Butyl pyridinium.

5. The lithium ion capacitor according to claim 1, wherein the electrolyte includes at least one among LiPF₆, LiBF₄ and LiClO₄.

6. The lithium ion capacitor according to claim 1, wherein the carbonate group solvent includes at least one among propylene carbonate, ethylene carbonate, diethyl carbonate, dimethyl carbonate and ethyl methyl carbonate.

7. The lithium ion capacitor according to claim 1, wherein the viscosity control solvent has a volume ratio ranging from ⅓ time to one time with reference to the carbonate group solvent.

8. The lithium ion capacitor according to claim 1, wherein the anode includes an anode collector and an active material layer disposed at least one surface of the anode collector and included therein pre-doped lithium ions.
